(19) United States
(12) Patent Application Publication
(10) Pub. No.: US 2023/0192331 A1
(43) Pub. Date: Jun. 22, 2023

(54) AUTONOMOUS AERIAL VEHICLE

(71) Applicant: Brijesh Kamani, Milpitas, CA (US)

(72) Inventor: Brijesh Kamani, Milpitas, CA (US)

(21) Appl. No.: 17/681,873

(22) Filed: Feb. 28, 2022

(30) Foreign Application Priority Data
Dec. 17, 2021 (IN) 202121059114

(51) Int. Cl. B64C 39/02; B64C 27/00; B64D 43/00; B64F 5/60; B64D 35/04; B64D 17/62

(52) U.S. Cl. CPC B64C 39/024; B64C 27/00; B64D 43/00; B64F 5/60; B64D 35/04; B64D 17/62; B64D 2221/00; B64C 2201/145; B64C 2201/12; B64C 2201/06; B64C 2201/146

(57) ABSTRACT

A modular autonomous aerial passenger vehicle is provided to automatically transport any person or luggage or capable of being used by the defense organizations for monitoring without any interference or need of human pilot. The autonomous aerial vehicle is comprising of an aerodynamic main body having 4 fixed arms each and 2 foldable arms each of which further having a pair of propellers coupled at the edge of each foldable arm, one at the top and one at the bottom. Further, the autonomous aerial vehicle further includes a power management system; safety system; interior cockpit having a HMI and seating arrangement, where the HMI is a brain computer interface that acquires signals from the brain and analyses them to convert it into commands. It includes a display unit and manual control unit; primary and auxiliary battery modules, flight control unit, plurality of sensors and cameras and other safety equipment for safe functioning of the present autonomous aerial vehicle.

### CROSS REFERENCE TO RELATED APPLICATION

This application claims the benefit of Indian Non Provisional Application no. 202121059114 filed on Dec. 17, 2021, by the present inventor; the disclosure is hereby incorporated by reference.

### FIELD OF INVENTION

The present invention generally relates to an autonomous aerial vehicle. More particularly, it relates to a modular autonomous aerial passenger vehicle which can automatically navigate itself and fly from one place to another based on the destination set on GPS by the passenger.

### BACKGROUND

Vehicle control systems are well known in the art, one known example being a control system that enables a human operator to remotely manage and control an unmanned vehicle. In one known application, an operator remotely controls an unmanned aerial vehicle (UAV) through a human-system interface. But these UAVs have inherent safety concerns due to lack of onboard human pilots. Many known control systems are not adaptable to on-going command-and-control software development efforts.

Moreover, modern local transportation networks rely heavily on ground infrastructure for the transportation of goods and people. More than half of the earth's population now lives in cities, with more than half a billion people living in megacities with populations exceeding 10 million people. In these high-density urban environments demand on ground transportation infrastructure has increased and continues to increase to the point that many metropolitan areas are heavily congested and road transportation networks are very inefficient. Traffic congestion is increasing in major cities and delays are becoming more frequent in smaller cities and rural areas.

Furthermore, considering the speed at which the automobile market is moving from petrol/diesel to electric vehicles, and that sooner or later ground level traffic congestions will give rise to the proliferation of aerial vehicles, there is an imminent need to build sustainable, powerful, safe and automatic electric aerial vehicles. The current prototypes cater to specific yet and futuristic components that are failing to abridge the current need of the market. The existing systems focus only on regular and basic passenger vehicles which do not cater to mission critical jobs and do not require any high-level decision-making and control abilities.

Existing inventions lack automatic navigation and control as well as usability for critical use-cases. Therefore, there currently exists a need in the industry for an autonomous aerial passenger vehicle which may serve as an automated Guided Vehicle that may fly and take passenger to the location he/she wants automatically. Further, it would also be desirable to have the vehicle automatically navigate and control itself without any manual intervention or requirement of any pilot. Still further, it would be desirable to have this aerial vehicle to be used for managing emergency situations, police patrolling, and defense use-cases and for package delivery.

### SUMMARY OF THE INVENTION

This summary is provided to introduce a selection of concepts in a simplified form that are further disclosed in the detailed description of the invention. This summary is not intended to identify key or essential inventive concepts of the claimed subject matter, nor is it intended for determining the scope of the claimed subject matter.

The present invention satisfies the needs and alleviates the problems discussed above. The purpose of this present invention is to provide an autonomous aerial passenger vehicle which is capable to navigate and fly to reach at the desired locations automatically without need of skilled pilot. According to one aspect, autonomous aerial vehicle is equipped with a drive by wire system to maneuver the vehicle either manually or autonomously.

According to one aspect, the autonomous aerial vehicle has the ability to auto navigate and control the system removing the dependency of manual control and pilot role. Furthermore, having an artificial intelligence the autonomous aerial vehicle is able to avoid the obstacles, choose the optimal path, select the best landing area, recognize objects and can also have more decision making abilities.

According to one another aspect, vehicle aerodynamics system of the vehicle comprises of mechanical structure, user display and configuration interface, artificial intelligence based control and navigation system, safety system, electric system which are configured in a way which allows the passenger to reach at the destined location without any human interference.

According to one another aspect, the payload capacity of the vehicle allows passenger to travel inside the vehicle. With the interior sitting arrangements at least one passenger is allowed to sit inside the vehicle, put on seat belt and turn on the safety systems, configure the destination location in display interface commanding the autonomous vehicle to take flight and reach the destination location through AI based control and navigation system. Once reached, the autonomous vehicle lands at the location and allows passenger to get out through the doors. The autonomous vehicle of present invention further comprises a brain computer interface to have destination detection from the thoughts of a person sitting inside the autonomous aerial passenger vehicle.

According to one another aspect, the autonomous aerial vehicle of present invention is further capable of being used as an air ambulance in medical emergency or a delivery system for food packets or cargo transport. Further, the aerial vehicle of present invention may be used for life scanning in a disaster prone area using the thermal cameras configured within the vehicle. It is further capable of being used as a defense vehicle for border activity monitoring by armed military or for police patrolling.

According to one aspect, the autonomous aerial passenger vehicle is provided with an AI powered navigation system where the AI algorithm of the vehicle determines the safest and shortest route for the destination being entered by the passenger or being automatically entered by the remote control/communication station in case of unmanned function of present autonomous aerial vehicle.

According to one aspect, the autonomous aerial vehicle of present invention includes safety system provided to monitor and control plurality of safety functions such as battery protection and monitoring feature that monitors battery status of vehicle in real time and prevents it from totally discharging at any moment; an object detection that detects any object nearby the aerial vehicle and accordingly controls working of said aerial vehicle; a current consumption and motor status detection to detect health of each motor of the vehicle, and seat belt detection to check if the seat belt is worn by the user or not and accordingly remind or notify the user of present aerial vehicle.

According to one aspect, the aerial vehicle of present invention further includes 3D camera to find or determine suitable land for landing of an aerial vehicle; a fire safety and smoke detection module of present safety system that detects any short circuit or fire within the vehicle and accordingly enables fire prevention/control mechanism as well as lands the vehicle safely and instantly; a communication module to facilitate vehicle to vehicle and vehicle to station communication.

Moreover, the aerial vehicle of present invention further includes an audio based control system provided to allow the aerial vehicle to instruct or notify the user using audio, a ballistic parachute, emergency oxygen system, cooling system for motors and propellers and many more other safety features configured to prevent any harm to the vehicle and the passenger.

### BRIEF DESCRIPTION OF THE DRAWINGS

The foregoing and other objects, features, and advantages of the devices and systems described herein will be apparent from the following description of particular embodiments thereof, as illustrated in the accompanying figures.

FIG. 1 shows one exemplary embodiment of present autonomous aerial passenger vehicle.

FIG. 2 shows top of same embodiment of present autonomous aerial passenger vehicle as shown in FIG. 1.

FIG. 3 shows front view of said exemplary embodiment of autonomous aerial passenger vehicle.

FIG. 4 illustrates system architecture diagram of autonomous aerial vehicle in accordance with the embodiment of present invention.

FIG. 5 illustrates a simplified block diagram of components of the autonomous aerial vehicle in accordance with the embodiment of the present invention.

FIG. 6 illustrates battery modules embodied in the autonomous aerial vehicle showing the modular design of the vehicle.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without departing from the scope of the disclosure.

The present disclosure relates to a modular autonomous aerial vehicle. The present invention uses AI based control and navigation system which has capability to fly and reach to destination with safest and shortest way possible. According to one embodiment, the modular platform is an assembly of components which includes but are not limited to battery pack, motor assembly comprising propeller and gearbox, arms to mount motors, electrical system (including wiring harness, s&p components), landing system, motor controllers and a platform supervisory controller (PSC). According to one embodiment, the platform can be bolt-on with a number of other system which can together form a vehicle that can fly. PSC is comprised of basic software to take command from an external system to fly to a desired destination. According to another embodiment, PSC has a “test mode” and a basic software to fly for a very short time to a very short distance. According to one embodiment, the bolt-on system comprises navigation system which can be controlled by human or can be autonomous, HMI system which helps the autonomous vehicle to decide route selection, to provide information and entertainment and vehicle parameters. According to another embodiment, the bolt-on system comprises an arrangement of a closed cabin of various configurations serving wise variety of applications. In another embodiment of the invention, the system may further include brain-computer interface; which may be coupled to the components of the aerodynamic mechanical structure and give desired results; wherein the passenger sits in the vehicle and the brain-computer interface system acquires brain signals of the passenger, analyzes them and translates them into commands which is passed to respective output device which then carries out the desired action.

According to one embodiment, autonomous aerial vehicle is equipped with a drive by wire system to maneuver the vehicle either manually or autonomously. Furthermore, manual or autonomous navigation system of the present invention is supported by variety of sensors that creates environmental map of surrounding. According to another embodiment, autonomous aerial vehicle is modular having cabins with different configurations that can be fit on top to cater various applications. Cabins with different configurations could be, 2 seat with space for luggage, single seat with cargo space for commercial/medical application, four seat with no luggage space for tourism application. According to another embodiment, the autonomous aerial vehicle has ability to auto navigate and control, removing dependency of manual control and pilot role. According to one embodiment, the modular platform of the autonomous aerial vehicle provides flexibility to the user to either use platform with own navigation system or source platform along with the navigation system.

According to one embodiment, the invention provides a modular aerial vehicle that is capable of being used for multiple different purposes such as providing travelling for people from one location to another, working as an ambulance for healthcare facilities, to deliver food packages or cargo for transportation and/or delivery industries, to scan and monitor any geographical area from the sky using the thermal cameras configured within it, to be used by defense agencies to monitor border activities and for patrolling by police.

According to one embodiment, the autonomous aerial vehicle of present invention is embedded with AI powered safety and control system which requires the user to just select the destination location using the display and interface system provided at the front portion of cockpit or remotely from any remote station communicatively coupled with present autonomous aerial vehicle. The AI of present invention, from the destination location entered by the user, automatically determines safest and shortest possible route to fly and reach the destination.

According to one embodiment, the present autonomous aerial vehicle utilizes a renewable energy source such as electricity for all its functioning. According to one embodiment, the autonomous aerial vehicle is embedded with number of rechargeable battery cells that are assembled together and serves as a battery module. The number of battery modules then are connected together physically and electrically and forms a part of the battery pack. According to one embodiment, the battery pack module configured at the bottom section of the main body of the autonomous aerial vehicle situated beneath the cockpit and sitting arrangement that powers all the motors and other safety equipment for safe functioning of present autonomous aerial vehicle. According to one embodiment, a structure holds the battery modules and acts as a structure to connect/house different parts of the platform together and can house different other components including but not limited to energy measurement devices, switch and protection devices. According to one embodiment, the battery skateboard can be expanded further length wise to increase overall length by adding more battery modules and overall available power. According to another embodiment, the expanded battery along with a higher capacity motor can carry larger loads or more passengers depending on the application which includes but not limited to medical tourism, cargo. According to one more embodiment, the shape of the battery can be flat but the size and shape of the battery can vary according to need and use of the vehicle.

According to one embodiment, the autonomous aerial vehicle of present invention is comprising mainly of: an aerodynamic mechanical structure or a main body that embeds all the other systems required for safe working of the autonomous aerial vehicle, where the main body or the structure is designed in a way that it may easily fly with less air resistance and increased uplift; a power system to regulate and provide power supply to all the other systems and components of present autonomous aerial vehicle; a flight control unit provided to controls speed and direction of the autonomous aerial vehicle; a plurality of motors connected with each propeller and a separate motor controller to control the speed of rotation of propeller; and a human machine interface (HMI) provided at the front portion within the cockpit of the autonomous aerial vehicle in the form of touch and voice sensitive display configured to allow user to communicate and manually control the autonomous aerial vehicle.

According to one embodiment, the autonomous aerial vehicle further includes a communication module or system configured within the vehicle which is provided to allow communication between two autonomous aerial vehicle or between vehicle and remote management station configured to control air traffic and to navigate any autonomous aerial vehicle in emergency such as crash of the autonomous aerial vehicle. According to one embodiment each of the plurality of motor of present invention is connected with at least one propeller that rotates the propeller to fly the autonomous aerial vehicle.

Further, the autonomous aerial vehicle of present invention further embedded with plurality of sensors which provides necessary information regarding the real time parameters such as temperature, air pressure, velocity, acceleration, nearby object etc. According to one embodiment, the autonomous aerial vehicle includes an open space within the main body without any HMI or cockpit allowing the vehicle to work as an unmanned aerial vehicle for transportation/delivery of goods or for monitoring functions. According to one another embodiment, the autonomous aerial vehicle of present invention includes a sitting arrangement along with the HMI in cockpit (hollow chamber) of the main body allowing the vehicle to work as an autonomous aerial passenger vehicle.

According to one embodiment, the autonomous aerial vehicle of present invention is further embedded with an AI based safety system directly connected with the flight control system and provided to facilitate with backup batteries, air pressure control, remote control from communication center, parachute release in emergency, short-circuit or electronic hazard prevention and control, fire prevention and control, water landing assistance, oxygen control etc. According to another embodiment, the autonomous aerial vehicle is equipped with fully redundant fail-safe system which is achieved through each motor powered with separate battery modules and further made safe by separate electrical isolation system.

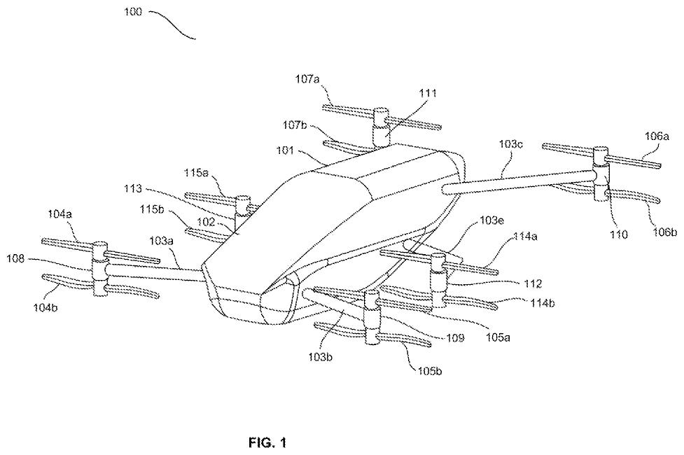

Referring to FIG. 1 now, which illustrates view of one exemplary embodiment of the autonomous aerial vehicle 100 of present invention. According to present embodiment, the autonomous aerial vehicle is made of a main body 101 which is an aerodynamic mechanical structure to easily fly within air with less air resistance and also designed in a way to provide as much internal space for transportation of people or any other object as possible. According to one embodiment, the autonomous aerial vehicle 100 of present invention includes a rechargeable battery module placed at the bottom beneath the sitting arrangement and covered under the flooring, where the battery is provided to power all the components of the autonomous aerial vehicle 100 for their functioning making the autonomous aerial vehicle 100 user friendly without any emission of toxic gases in air.

According to one embodiment, the main body 101 of the autonomous aerial vehicle 100 includes a sitting arrangement within the cockpit for two persons when working as the autonomous aerial passenger vehicle to transport people from one location to another. A human machine interface (HMI) is provided at the front section of the autonomous aerial vehicle 100 within the cockpit to allow the user to monitor and manually control the autonomous aerial vehicle 100 when needed. According to one embodiment, the HMI includes a touch display configured at the front section within the cockpit to facilitate the user with visual data in real time as well as to allow the user to control by touching the functional visible on the display.

According to one embodiment, a transparent front glass 102 is provided at the front of the main body 101 of the autonomous aerial vehicle 100 to facilitate the user sitting inside the vehicle 100 to have a vision of an environment and/or scenery outside the vehicle 100 to allow the user to control the vehicle manually using HMI when the automatic system fails.

According to one embodiment, the autonomous aerial vehicle 100 of present invention includes a plurality of fixed and retractable or foldable arms [103a, 103b, 103c, 103d, 103e and 103f1] extending out from the front and back sides of retractable which couples a plurality of propellers with the main body 101 of the autonomous aerial vehicle 100. The number of arms can be changed according to the needs and use of the vehicle. According to one embodiment of the invention, each arm of the autonomous aerial vehicle can support two motors coaxially or support one single motor. Moreover, the motors on the same arm can be co-axial or independent. According to present embodiment, the main body 101 of the autonomous aerial vehicle 100 comprises fixed arms extending from front right side 103a, front left side 103b, back left side 103c and back right side 103d of the main body 101 of autonomous aerial vehicle 100, where each support art extends at an angle from the main axis of the main body 101. The main body 101 of the autonomous aerial vehicle 100 comprises foldable arms extending from middle right hand side 103e and middle left side 103f of the main body 101 of autonomous aerial vehicle 100.

According to one embodiment, the propellers of the autonomous aerial vehicle 100 is coupled with the dedicated motor and a motor controller which is further connected with the AI based flight control unit and a battery module which automatically controls the speed and direction of rotation of each propeller by manipulating rotation of motor using the motor controller of each propeller. According to one embodiment, the motor controller controls the motor's output by controlling motor's current and voltage. The motor controller may control a single motor or a set of motors. According to one embodiment, PSU takes input from various components of the platform assembly and sends command to individual motors. The inputs include position of the flight on ground and in flight, temperature data from various components, energy level in the battery pack per cell and per module, motor rpm and faults in the system.

According to one embodiment, the AI based flight control unit of present autonomous aerial vehicle 100, using the real time data received from the plurality of sensors embedded within the autonomous aerial vehicle 100 and based on the commands and/or signal received from the user or from remote center, manipulates speed of rotation of the motor hence the propeller coupled with said motor.

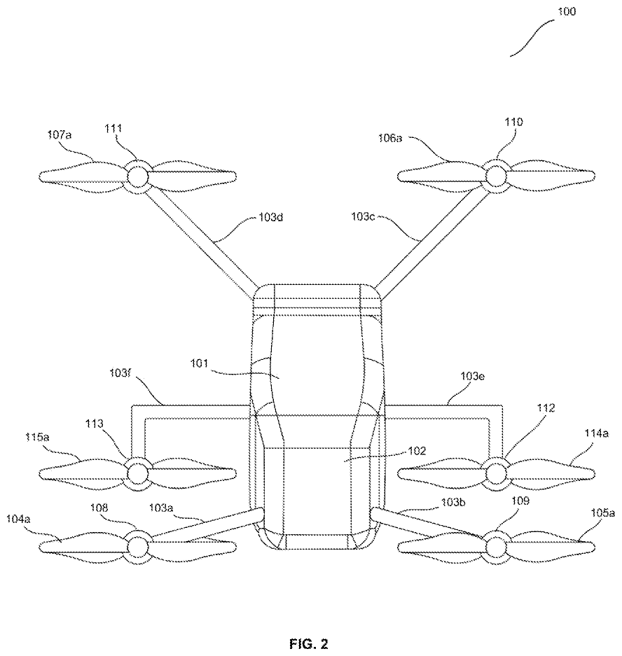

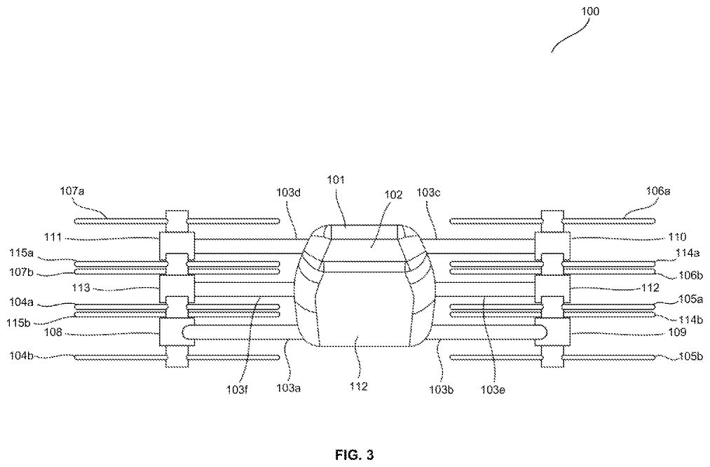

FIG. 2 and FIG. 3 shows a top and front view of an exemplary embodiment of the autonomous aerial vehicle 100. According to one embodiment, a pair of propellers (top and bottom) configured at the edges of each arm support [103a, 103b, 103c, 103d, 103e and 103f] which are provided to propel the autonomous aerial vehicle 100 up in the air. According to one embodiment, each propeller of the autonomous aerial vehicle 100 is connected with a dedicated motor and motor controller unit which rotates the propeller by harnessing power from the battery module.

According to present embodiment, a pair of a propeller having a top propeller 104a and a bottom propeller 104b is connected with the front right support arm 103a and coupled with a dedicated motor and motor controller enclosed within the connection assembly 108. Similarly, each other supporting arm [103b, 103c, 103d, 103e and 103f] is provided with a set of top and bottom propellers [105a-105b, 106a-106b, 107a-107b, 114a-114b and 115a-115b] respectively coupled at the edges of the foldable supporting arms through a connection assemblies [109, 110, 111, 112 and 113].

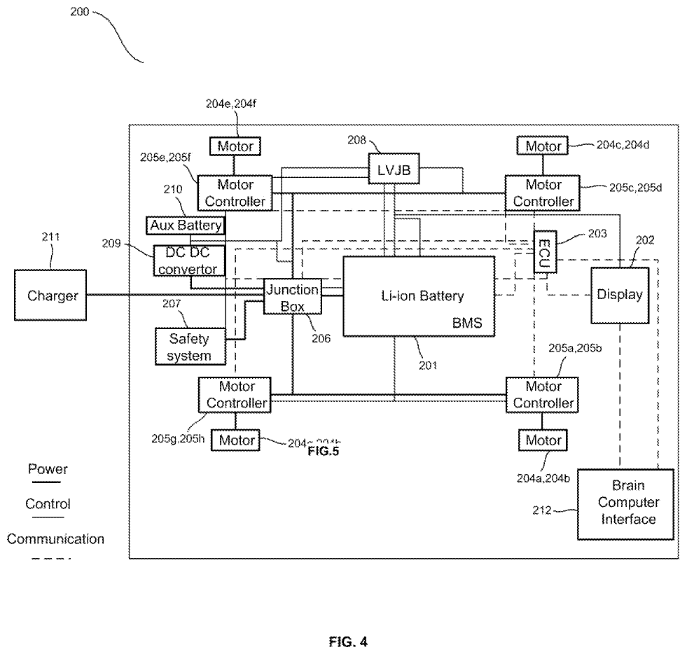

FIG. 4 illustrates power system architecture diagram 200 of the autonomous aerial vehicle 100 displaying connections between the components and systems of the autonomous aerial vehicle 100 for transmission of power, control and communication signals. According to present embodiment, the autonomous aerial vehicle 100 is comprising of a panel of battery or a battery skateboard module 201 mounted at the center beneath the floor of the seating arrangement which is connected with all the other components and safety equipment of present autonomous aerial vehicle 100 to provide electric power for their functioning. A display unit 202 configured at the front portion of the autonomous aerial vehicle 100 coupled with the battery module 201 to harness power and facilitate user with an human machine interface (HMI) so that the user may communicate and control the autonomous aerial vehicle 100.

An electronic control unit (ECU) 203 is configured communicatively coupled with a brain computer interface (BCI) 212 which is further connected with the display unit 202 to work as a brain of the flight controller that receives real time data from the sensors, commands from user and accordingly manipulate operations of each equipment of the autonomous aerial vehicle 100 for its safe operation. According to one embodiment, the autonomous aerial vehicle 100 includes eight electric motors (204a, 204b, 204c, 204d, 204e, 204f, 204g and 204h) each of which is connected with the battery module 201 through a separate motor controller (205a, 205b, 205c, 205d, 205e, 205f, 205g and 205h) each of which are communicatively coupled with the ECU 203 to receive command and manipulate speed of rotation of the motor. The number of motors can vary according to the needs of the vehicle. According to one embodiment, the brain-computer interface 212 acquires brain signals of the user, commands the control system 203 of the autonomous aerial vehicle 100 based on the analyzed brain signals of the user and displays the command on the display 202 of the vehicle. According to one embodiment, the electronic control unit coupled to the electric power source is configured to dynamically activate or deactivate each of the eight motors based on one or more operating conditions of the autonomous aerial vehicle. According to one embodiment, the autonomous aerial vehicle includes four attachable electric power gear assemblies configured to couple the eight motors to a propeller shaft for providing the torque to the blades. According to one embodiment, the attachable electric power gear assembly is modular such that higher capacity motors could be replaced to carry heavy load.

According to one embodiment, the autonomous aerial vehicle 100 further includes a junction box 206 through which the battery unit 201 connects with all the other components. According to one embodiment, the junction box 206 is provided with a fuse and other safety equipment to prevent overcurrent, voltage or current fluctuations and thus protects from short circuit and fire. A safety system 207 is provided that monitors real time sensory data and protects the autonomous aerial vehicle 100 from any accident and or failure.

According to one embodiment, the safety system 207 is connected with the battery module 201 through the junction box 206. According to one embodiment, the autonomous aerial vehicle 100 of present invention further includes an auxiliary battery module 201 connected within the junction box 206 and with all the other components through a DC-DC converter 209 that converts higher voltage level to lower voltage level according to requirement of each electrical equipment embedded within the autonomous aerial vehicle 100. According to one embodiment, the auxiliary battery 210 is provided to work as a back-up battery to safely land the vehicle when the primary battery is completely discharged during flying.

According to one embodiment, the autonomous aerial vehicle 100 includes a charging port provided within the junction box 206 to couple the charger 211 and charge the battery module 201 of the autonomous aerial vehicle 100. According to one embodiment, the safety module 207 of the autonomous aerial vehicle 100 also includes an AI based control module or a controller in communication with all the sensors that receives real time sensory data from all the sensors and accordingly commands the other equipment and systems of the autonomous aerial vehicle 100 to provide safety functions to prevent any system failure, accident or crash.

According to one embodiment, the safety system 207 of the autonomous aerial vehicle 100 monitors real time health of the battery module 201 as well as the charging level of the battery module 201 to determine remaining flying time. In case of emergency or failure of primary battery 201, the safety system 207 of the autonomous aerial vehicle 100 switches to the auxiliary battery 210 which prevents further ride of the autonomous aerial vehicle 100 and just allows it to safely land.

According to one embodiment, the safety system 207, using thermal cameras and sensors configured within the autonomous aerial vehicle 100, detects any object in pre-defined range from the autonomous aerial vehicle 100 and accordingly control automatic flying of the autonomous aerial vehicle 100. According to one embodiment, the safety system 207 further checks safety of the user by real time monitoring seat belt status using the switch or proximity sensors configured within seating arrangement.

The autonomous aerial vehicle 100 of present invention further includes a plurality of thermal and 3D cameras that monitors real time environment around the autonomous aerial vehicle 100 as well as works as an eye in fetching suitable land area for landing the autonomous aerial vehicle 100 by the safety system 207. According to one embodiment, the safety system 207 includes a smoke detection sensor to detect any fire or short circuit in any equipment or system of the autonomous aerial vehicle 100 and automatically enables fire safety system with commanding emergency landing to the flight control unit of the autonomous aerial vehicle 100.

According to one embodiment, the safety system 207 is embedded with a communication module which is configured to allow communication between two nearby autonomous aerial vehicles 100 or between the autonomous aerial vehicle 100 and a remote station. The communication module facilitates safety system to communicate with the remote station when detected any emergency situation and also shares the real time location of the autonomous aerial vehicle 100 allowing the control station to manually control the autonomous aerial vehicle 100 from remote location as well as to send and aid for rescue of the user present within the autonomous aerial vehicle 100.

The communication module further provides communication with other nearby autonomous aerial vehicle 100 in case of failure of contact with the remote station in emergency situation. According to one embodiment, the safety system 207 of present autonomous aerial vehicle 100 further includes a plurality of current sensors coupled with each motor of the autonomous aerial vehicle 100 that monitors real time current consumption of each motor to predict and or determine health of the motors. A cooling system is also provided as a part of the safety system 207 to continuously cool the motors and propellers of the autonomous aerial vehicle 100.

According to one embodiment, the safety system 207 further provides a safety features for the users as well as features which allows user to select and control the autonomous aerial vehicle 100. The safety system 207 of present autonomous aerial vehicle 100 provides speed detection sensor that detects speed of the autonomous aerial vehicle 100 which the safety system continuously displays in the front display provided within the autonomous aerial vehicle 100 enabling user to control if the autonomous aerial vehicle 100 flies over the required speed limits.

An audio based control system is provided using which the safety system 207 instructs the status of the autonomous aerial vehicle 100 for example “Vehicle ready to take off” or “ready to land” or “battery low, charging is required” etc. According to one embodiment, the safety system 207 of present autonomous aerial vehicle 100 further provides a parachute and an emergency oxygen system for emergency situation for the safety of the user present within the autonomous aerial vehicle 100. According to one more embodiment, the safety system further allows the user to contact anyone via video or an audio call with one tap on display provided as an HMI for the user.

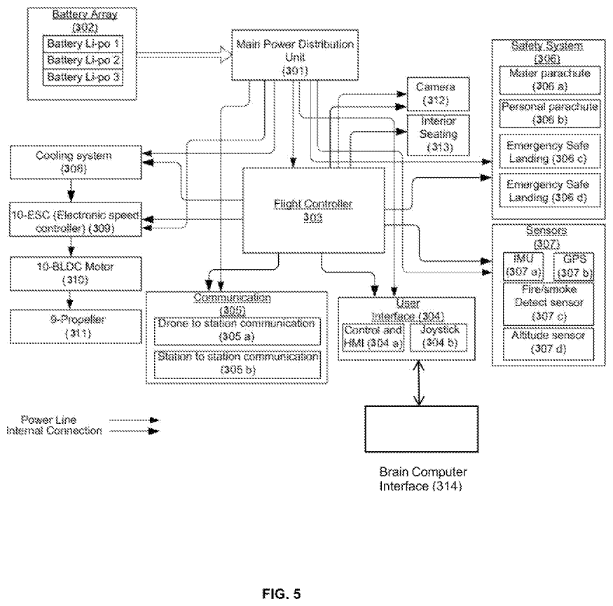

In one embodiment of the invention, aerodynamic mechanical structure houses different components which are configured to achieve desired results as mentioned above. FIG. 5 depicts different components of one more embodiment of the autonomous aerial vehicle 100. The component includes main power distribution unit 301, Battery module 302, Flight controller unit 303, User Interface 304 which comprises of Control and HMI 304a and Joystick 304b, and brain computer interface 314, Communication system 305 which includes drone to station communication 305a and station to station communication 305b, Safety system 306 which consists of Mater parachute 306a, Personal parachute 306b and Emergency safe landing 306c, Plurality of sensors 307 which comprises of Inertial Measurement Unit (IMU) 307a, GPS 307b, Fire/smoke detector 307c and altitude detection sensors 307d, Cooling system 308, Electronic speed controller 309, BLDC Motor 310, propeller 311, Multiple 3D and infrared cameras 12 and Interior seating 313.

As described in FIG. 5, the power system 301 harnesses power from the battery module 302 and provides controlled power to all the other components and system of the autonomous aerial vehicle 100 for their working. In another embodiment of the invention, the vehicle is equipped with interior seating 313 for the passenger to sit inside the vehicle. The passenger interacts with control and HMI system 304a for setting up location, changing preferences and other controls. Furthermore, Control and HMI system 304a interfaces with flight controller unit 303 and provides input data from user to operate and navigate the autonomous aerial vehicle as per the inputs provided. According to one embodiment, the brain computer interface 314 acquires brain signals of the user and communicates the same via user interface 304 and sends to flight controller 303. The BLDC motor 310 is connected to the individual motors which is ultimately connected to the propellers 311. Moreover, the flight controller module 303 controls the electronic speed controller 309 which controls the BLDC motor 310 to operate at desired speed and rotates the propeller 311 to take flight and navigate the autonomous vehicle in the air.

In another embodiment of the invention, sensors 307 which includes fire/smoke detector sensor 307c, and altitude sensor 307d is connected to the flight controller module 303 to provide necessary information regarding the real time parameters such as temperature, air pressure, velocity, acceleration etc. Furthermore, communication system 305 provides access to communication from vehicle to connected communication center 305a and also provides access to communication from station to station 305b.

In yet another embodiment of the invention, safety system 306 is directly connected to flight controller 303 and provides features like backup batteries, air pressure controlling, remote control communication center, parachute release, electronic hazard/short circuit, sire system, water landing, oxygen source with masks in case of emergency or air pressure imbalance. Moreover, the cooling system 308 is connected to the motors and flight control unit 303 to maintain the temperature inside the vehicle while travelling. Moreover, the system components are protected by hardware redundancy which detects the particular failure and responds with an action to mitigate the consequences. The hardware redundancy works as a system backup wherein if any of the component of the vehicle fails while performing, this hardware redundancy works in accordance with the function of that component.

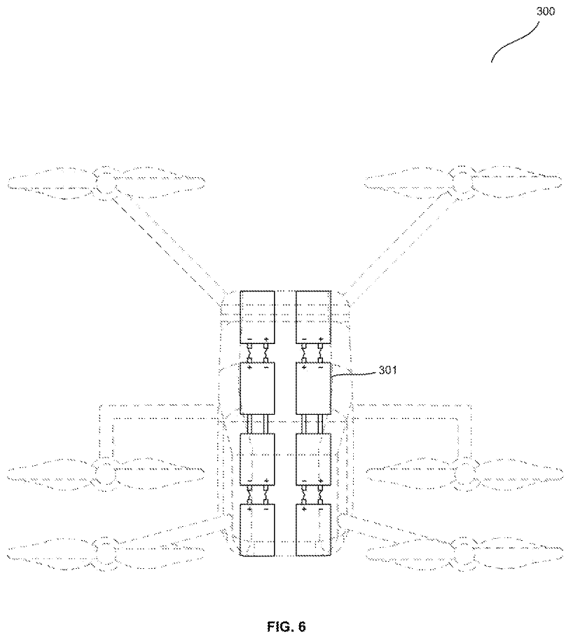

In another embodiment, FIG. 6 illustrates top view of the autonomous aerial vehicle showing battery module forming base configuration of the autonomous aerial vehicle 300. The battery module is placed at the bottom beneath the sitting arrangement and covered under the flooring. The battery 301 is arranged parallelly to each other in a way forming battery skateboard module. According to one embodiment, the base configuration of the vehicle can accommodate any structure 302 on the top depending on the application of the autonomous aerial vehicle. According to one embodiment, the battery skateboard module can be expanded further length wise to increase overall length by adding more battery modules and overall available power. According to another embodiment, the expanded battery along with a higher capacity motor can carry larger loads or more passengers depending on the application which includes but not limited to medical tourism, cargo.

In another embodiment, a pair of propellers (top and bottom) configured at the edges of each arm support are provided to propel the autonomous aerial vehicle up in the air and each are connected with a dedicated motor and motor controller unit which rotates the propeller by harnessing power from the battery module. A pair of a propeller having a top and bottom propeller is connected with the support arm and coupled with a dedicated motor and motor controller enclosed within the connection assembly.

In another embodiment of the present invention, the control and navigation system software can be connected to the internet. Thus, according to the necessities the software can be upgraded and more features can be introduced later also.

In another embodiment of the present invention, the aerodynamic mechanical structure of autonomous aerial vehicle consists of 4 number of fixed arms and 2 foldable arms; wherein the 4 numbers of fixed arms has two propellers arranged over one another in horizontal plane which helps to take of the vehicle, while 2 foldable arms are for horizontal fast movement to avoids turbulence. Each propeller is connected with separate motor with or without gear box. The aerodynamic mechanical structure of the vehicle having different arms with propeller can get folded when parked and can be accommodated in smaller space than in normal state with open arms. Moreover, the compact dimensions of the vehicle lets the vehicle land on any household or apartment building terrace.

In another embodiment of the invention, the autonomous aerial vehicle incorporates black box which works as an electronic flight data recorder. Further, the black box keeps detailed tracks of on-flight information, records all flight data such as altitude, position and speed, cabin temperature. Furthermore, the invention uses global central command system which works within the system and coordinates patterns to ensure vehicle keep a safe distance in the air. This monitors the movements of all the autonomous aerial vehicle flying in the air and provides the data relating to the movement at the same time which helps to prevent accidents in the air. According to one embodiment, the autonomous aerial vehicle can work with energy sources like fuel cell and/or transparent solar panels. However, the present description of the invention relies on the eVOLT technology.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

1. A multi-purpose autonomous aerial vehicle comprising of:
an aerodynamic mechanical structure or a main body having an internal cavity or a cockpit and four fixed arms and two foldable arms extending out from four corners and center of the multi-purpose autonomous aerial vehicle at an angle from the main axis of the main body;
a modular battery platform beneath the cockpit and sitting arrangement comprising rechargeable battery pack, motor assembly, arms to mount motor,
electrical system, landing system, motor controllers and platform supervisory controller (PSC);
a pair of propeller configured on edges of each foldable arm and arranged over one another in a horizontal plane;
a flight control unit having an electronic control unit (ECU) and provided to control speed, direction as well as automatic landing of the multi-purpose autonomous aerial vehicle;
a human machine interface (HMI) communicatively coupled with the flight control unit and configured to allow user to monitor, interact and manually command and control the multi-purpose autonomous aerial vehicle;
a brain computer interface to receive signals from the passenger, analyze and translate them into commands;
a plurality of various sensors to monitor and record real time parameters including temperature, air pressure, velocity, acceleration, motor health, short-circuit or fire, GPS, altitude and weight;
AI powered navigation system where the AI algorithm of the vehicle determines the safest and shortest route for the destination being entered by the passenger;
AI powered safety system coupled with all the plurality of various sensors and flight control unit; and
a power management system to manage, regulate and provide power supply to all the equipment and system of the multi-purpose autonomous aerial vehicle.

2. The multi-purpose autonomous aerial vehicle of claim 1, wherein four attachable modular electric power gear assemblies are configured to couple the eight motors to a propeller shaft.

3. The multi-purpose autonomous aerial vehicle of claim 1, wherein each motor is coupled with a separate motor controller that control speed of rotation of the motor.

4. The multi-purpose autonomous aerial vehicle of claim 1, wherein each motor controller is communicatively coupled with and receive control commands from the flight control unit and accordingly manipulates speed of rotation of the motor.

5. The multi-purpose autonomous aerial vehicle of claim 1, wherein the HMI includes a touch and voice sensitive display configured at the front portion of a cockpit and provided to allow the user to manually control the multi-purpose autonomous aerial vehicle by tapping.

6. The multi-purpose autonomous aerial vehicle of claim 1, wherein the touch and voice sensitive display of the HMI further displays real time sensory data, safety instructions, environmental condition and emergency alerts for the user to monitor.

7. The multi-purpose autonomous aerial vehicle of claim 1, wherein the commands prepared by the brain computer interface are passed to respective output device and carries desired function.

8. The multi-purpose autonomous aerial vehicle of claim 1, wherein the ECU of the flight controller is coupled with the safety system to receive real time sensory data and command instruction to control the speed, direction as well as emergency landing of the multi-purpose autonomous aerial vehicle.

9. The multi-purpose autonomous aerial vehicle of claim 1, wherein the ECU of the flight controller is further coupled with the HMI to allow the user to manually command and control the multi-purpose autonomous aerial vehicle.

10. The multi-purpose autonomous aerial vehicle of claim 1, wherein the ECU of the flight controller is coupled to the electric power source which is configured to dynamically activate or deactivate each of the eight motors based on the one or more operating conditions of the autonomous aerial vehicle.

11. The multi-purpose autonomous aerial vehicle of claim 1, wherein the power management system includes a primary battery module mounted at the bottom of the main body and configured to supply power to each component, equipment and system of the multi-purpose autonomous aerial vehicle.

12. The multi-purpose autonomous aerial vehicle of claim 1, wherein the power management system further includes an auxiliary battery as a backup battery for emergency landing in case of failure or complete discharge of primary battery.

13. The multi-purpose autonomous aerial vehicle of claim 1, wherein the safety system is provided to facilitate with backup battery control, air pressure control, remote control from communication center, parachute release in emergency, short-circuit or electronic hazard prevention and control, fire prevention and control, water landing assistance, and oxygen control.

14. The multi-purpose autonomous aerial vehicle of claim 1, wherein the safety system is comprising of an AI based control module or a controller in communication with all of the plurality of various sensors to receive real time sensory data and command or control other equipment and systems of the autonomous aerial vehicle to provide safety functions to prevent any system failure, accident or crash.

15. The multi-purpose autonomous aerial vehicle of claim 1, wherein the safety system further monitors real time health of the primary battery module to determine remaining flying time.

16. The multi-purpose autonomous aerial vehicle of claim 1, wherein the safety system using a plurality of thermal cameras, 3D cameras, laser and proximity sensors, detects any object in pre-defined range of the multi-purpose autonomous aerial vehicle to prevent crash.

17. The multi-purpose autonomous aerial vehicle of claim 1, wherein the safety system, using a smoke detection sensor, detects any fire or short-circuit and automatically enables a fire safety system of the multi-purpose autonomous aerial vehicle.

18. The multi-purpose autonomous aerial vehicle of claim 1 further includes a cooling system provided as a part of the safety system to continuously cool each of the pair of propellers and motors.

19. The multi-purpose autonomous aerial vehicle of claim 1, wherein the safety system further includes a communication module configured to provide communication between vehicle to vehicle and vehicle to remote station.

20. The multi-purpose autonomous aerial vehicle of claim 1 further includes a junction box through which connects the primary battery module with all the other components of the multi-purpose autonomous aerial vehicle.

21. The multi-purpose autonomous aerial vehicle of claim 1 further includes a charging port provided within the junction box to couple an external charger to recharge the primary battery module.
